(19) United States
(12) Patent Application Publication
(10) Pub. No.: US 2026/0352454 A1
(43) Pub. Date: Nov. 5, 2026

(54) SYSTEMS AND METHODS FOR QUANTUM KEY DISTRIBUTION USING SEMI TRUSTED NODE QUANTUM NETWORKS

(71) Applicant: JPMORGAN CHASE BANK, N.A., New York, NY (US)

(72) Inventors: Ignatius William PRIMAATMAJA, Singapore (SG); Wen Yu KON, Singapore (SG); Kaushik CHAKRABORTY, Singapore (SG); Ci Wen LIM, Singapore (SG); Marco PISTOIA, New York, NY (US)

(21) Appl. No.: 19/196,537

(22) Filed: May 1, 2025

(51) Int. Cl. H04L 9/08

(52) U.S. Cl. CPC H04L 9/0858; H04L 9/0869

(57) ABSTRACT

Systems and methods for quantum key distribution (QKD) using semi trusted node quantum networks are disclosed. Each intermediate link in the system only performs the quantum communication, basis announcement, and parameter estimation of the QKD protocol. If parameter estimation passes for all links, the end-users may use an encrypted classical channel to create their respective raw keys. The intermediate nodes may then compute the parity of their raw keys, and the end-users may correlate their raw keys. The end-users may agree on a random substring of their raw key, whose length is half of the original raw key, on which they will perform the classical post-processing (error correction and privacy amplification). If the parameter estimation passes for all links, this means that the intermediate keys share very little correlation with the end-users' keys, and that an external adversary has very little knowledge of all of the intermediate keys.

### BACKGROUND OF THE INVENTION

### 1. Field of the Invention

Embodiments relate to systems and methods for quantum key distribution using semi trusted node quantum networks.

### 2. Description of the Related Art

Quantum key distribution (QKD) is a nascent technology that allows two distant parties to share a common secret key. Its distinctive feature is the promise of information-theoretic security: the security of QKD does not depend on any computational assumptions, which makes it quantum-safe (i.e., secure against attacks that rely on quantum computers). Early migration to QKD would protect organizations from the harvest now, decrypt later attacks, where malicious attackers store encrypted confidential data now and decrypt them later when large scale quantum computers become available.

While QKD has a huge potential in terms of security, a drawback to using QKD is its limited range. The signal loss in an optical fiber increases exponentially with the length of the fiber. Unlike in classical communications, at this time, the quantum signals used in QKD cannot practically be amplified. As quantum repeater technology is still in its infancy, the range of typical fiber-based QKD is limited to maximally hundreds of kilometers.

To address this drawback, a network of trusted nodes may be used to relay the secret keys between end-users. In a quantum network, each node must have the capability to perform quantum communication with the adjacent nodes. This means that each node must be able to send or receive (or both) quantum signals to its neighboring nodes.

To perform a secure key exchange between two end-users over a quantum network with trusted nodes, each pair of neighboring nodes will need to perform QKD to obtain some keys. Once each node shares a secret key with its neighbor, one of the end-users, say Alice, can then securely relay the key to the other end-user, say Bob, via a series of encryption between the trusted nodes.

To illustrate the key relay process, consider the case where there is one intermediate node, called Charlie. Suppose that Alice-Charlie and Charlie-Bob has performed their respective QKD protocol and obtain the keys K_{AC} and K_{BC}, respectively. Charlie (the intermediate node) can then relay Alice's key (i.e., K_{AC} to Bob by encrypting K_{AC} using the secret key K_{BC} that Bob and Charlie share. Charlie would then send the cyphertext to Bob using a classical channel. Since Bob also has access to K_{BC}, he can decrypt the cyphertext to obtain the Alice's key K_{AC}. Therefore, the end-users (Alice and Bob) have managed to share the secret key (in this case, K_{AC}).

The security of the protocol is derived from the security of QKD (which generates K_{AC} and K_{BC}), as well as the encryption scheme that is used by the intermediate node. For example, if the one-time-pad encryption is used, then the scheme is information theoretically secure against any external adversaries. This process can be extended straightforwardly when there are additional nodes in the quantum network.

One drawback of this scheme is that each node that relays the key will be able to reconstruct the end-users' key. This is the reason why the nodes in the quantum network have to be trusted—if one of the nodes is compromised, that node will be able to deduce the end-users' key. This is true even when the node is compromised after the completion of the protocol. Therefore, in the trusted node quantum network method, each node has to be trusted both during and after the protocol execution. During the protocol execution, each node needs to comply with the protocol. After the protocol execution, each node has to store (or delete) the key securely.

From the cryptographic point-of-view, the need to trust all of the intermediate nodes is very risky, and the need to secure all of the nodes is also very costly, especially when the number of nodes increases.

### SUMMARY OF THE INVENTION

Systems and methods for quantum key distribution using semi trusted node quantum networks are disclosed. In one embodiment, a method may include: receiving, by an intermediate party computer program and from a first party computer program, a first plurality of quantum systems prepared according to first party random bases and a first party random bit-string; receiving, by the intermediate party computer program and from a second party computer program, a second plurality of quantum systems prepared according to second party random bases and a second party random bit-string; measuring, by the intermediate party computer program, each of the first plurality of quantum systems as a first measurement using an intermediate party first randomly chosen basis and each of the second plurality of quantum systems as a second measurement using an intermediate party second randomly chosen basis, wherein the first measurements comprise first intermediate bit-values and the second measurement comprise second intermediate bit-values; announcing, by the intermediate party computer program and from the first measurements, a first set of matching rounds with detections to the first party computer program, and, from the second measurements, a second set of matching rounds with detections to the second party computer program; testing, by the intermediate party computer program, a first quantum communication channel between the first party computer program and the intermediate party computer program, and a second quantum communication channel between the second party computer program and the intermediate party; receiving, by the intermediate party computer program and from the first party computer program, indices of a first subset of rounds from the first party random bit-string that have the same basis as the intermediate party first randomly chosen basis, are not used for parameter estimation, and were detected by the intermediate party computer program; receiving, by the intermediate party computer program and from the second party computer program, indices of a second subset of rounds from the second party random bit-string that have the same basis as the intermediate party second randomly chosen basis, are not used for parameter estimation, and were detected by the intermediate party computer program; forming, by the intermediate party computer program, a first party intermediate bit-string using the first intermediate bit-values for rounds that share the same indices announced by the first party and a second party intermediate bit-string using the second intermediate bit-values that share the same indices announced by the second party; announcing, by the intermediate party computer program and to the first party computer program and to the second party computer program, parities of each bit in the first party intermediate bit-string and each bit in the second party intermediate bit-string; wherein the first party computer program is configured to discard a subset of the bits in the first party random bit-string and announce indices of the discarded bits to the second party computer program; wherein the second party computer program is configured to discard bits corresponding to the indices of the discarded bits from the second party random bit-string; and wherein the first party computer program and the second party computer program are configured to perform error correction and privacy amplification, resulting in a first party secret key and a second party secret key.

In one embodiment, the first party random bit-string comprises a first plurality of randomly chosen bit-values; and the second party random bit-string comprises a second plurality of randomly chosen bit-values.

In one embodiment, the method may also include: randomly selecting, by the intermediate party computer program, the intermediate party first randomly chosen basis and the intermediate party second randomly chosen basis.

In one embodiment, the first test subset of the first matching rounds and the second test subset of the second set of matching rounds are randomly selected.

In one embodiment, the subset of the bits discarded from the first party random bit-string comprises half of the plurality of bits in the first party random bit-string.

In one embodiment, the first party computer program is configured to announce the indices of the discarded bits to the second party computer program over an encrypted classical communication channel.

In one embodiment, the step of testing the first quantum communication channel between the first party computer program and the intermediate party computer program, and the second quantum communication channel between the second party computer program and the intermediate party comprises: receiving, by the intermediate party computer program and from the first party computer program, an announcement of a first test subset of the first set of matching rounds and from the second party computer program, an announcement of a second test subset of the second set of matching rounds; and providing, by the intermediate party computer program and to the first party computer program, first measurements for the first test subset and providing the second party computer program with second measurements for the second test subset.

According to another embodiment, a system may include: a first party electronic device executing a first party computer program; a second party electronic device executing a second party computer program; and an intermediate party electronic device executing an intermediate party computer program. The first party computer program prepares a first plurality of quantum systems according to first party random bases and a first party random bit-string and sends the first plurality of quantum systems to an intermediate party computer program; the second party computer program prepares a second plurality of quantum systems according to second party bases and a second party random bit-string and sends the second plurality of quantum systems to the intermediate party computer program; the intermediate party computer program measures the first plurality of quantum systems as a first measurement using an intermediate party first randomly chosen basis and the second plurality of quantum systems as a second measurement using an intermediate party second randomly chosen basis, wherein the first measurements comprise first intermediate bit-values and the second measurement comprise second intermediate bit-values; the intermediate party computer program announces, from the first measurements, a first set of matching rounds with detections to the first party computer program, and, from the second measurements, a second set of matching rounds with detections to the second party computer program; the intermediate party computer program tests a first quantum communication channel between the first party computer program and the intermediate party computer program, and a second quantum communication channel between the second party computer program and the intermediate party; the intermediate party computer program receives, from the first party computer program, indices of a first subset of rounds from the first party random bit-string that have the same basis as the intermediate party first randomly chosen basis, are not used for parameter estimation, and were detected by the intermediate party computer program; the intermediate party computer program receives, from the second party computer program, indices of a second subset of rounds from the second party random bit-string that have the same basis as the intermediate party second randomly chosen basis, are not used for parameter estimation, and were detected by the intermediate party computer program; the intermediate party computer program forms a first party intermediate bit-string using the first intermediate bit-values for rounds that share the same indices announced by the first party and a second party intermediate bit-string using the second intermediate bit-values that share the same indices announced by the second party; the intermediate party computer program announces, to the first party computer program and to the second party computer program, parities of each bit in the first party intermediate bit-string and each bit in the second party intermediate bit-string; the first party computer program discards a subset of the bits in the first party random bit-string and announce indices of the discarded bits to the second party computer program; the second party computer program discards bits corresponding to the indices of the discarded bits from the second party random bit-string; and the first party computer program and the second party computer program perform error correction and privacy amplification, resulting in a first party and a second party secret key.

In one embodiment, the first party computer program randomly chooses the first party random bit-string and the first party random bases, and the first party random bit-string comprises a first plurality of randomly chosen bit-values; and the second party computer program randomly chooses the second party random bit-string and the second random basis, and the second party random bit-string comprises a second plurality of randomly chosen bit-values.

In one embodiment, the intermediate party computer program measures the first plurality of quantum systems in intermediate party first randomly chosen bases, the second plurality of quantum systems in intermediate party second randomly chosen bases, and the intermediate party computer program announces the intermediate party first randomly chosen bases to the first party computer program, and the intermediate party second randomly chosen bases to the second party computer program.

In one embodiment, the first party computer program computes the first set of matching rounds with matching basis and selecting a first test subset of the first set of matching rounds; and the second party computer program computes the second set of matching rounds with matching basis and selecting a second test subset of the second set of matching rounds.

In one embodiment, the subset of the bits discarded from the first party random bit-string comprises half of the plurality of bits in the first party random bit-string.

In one embodiment, the intermediate party computer program tests the first quantum communication channel between the first party computer program and the intermediate party computer program, and the second quantum communication channel between the second party computer program and the intermediate party by: the intermediate party computer program receiving, from the first party computer program, an announcement of a first test subset of the first set of matching rounds and from the second party computer program, an announcement of a second test subset of the second set of matching rounds; and the intermediate party computer program providing, to the first party computer program, the first measurement selected from the first test subset and responding to the second party computer program with the second measurement selected from the second test subset.

According to another embodiment, a non-transitory computer readable storage medium may include instructions stored thereon, which when read and executed by one or more computer processors, cause the one or more computer processors to perform steps comprising: receiving, from a first party computer program, a first plurality of quantum systems prepared according to first party random bases and a first party random bit-string; receiving, from a second party computer program, a second plurality of quantum systems prepared according to second party random bases and a second party random bit-string; measuring, the first plurality of quantum systems as a first measurement using an intermediate party first randomly chosen basis and the second plurality of quantum systems as a second measurement using an intermediate party second randomly chosen basis, wherein the first measurements comprise first intermediate bit-values and the second measurement comprise second intermediate bit-values; announcing, from the first measurements, a first set of matching rounds with detections to the first party computer program, and, from the second measurements, a second set of matching rounds with detections to the second party computer program; testing a first quantum communication channel between the first party computer program and the intermediate party computer program, and a second quantum communication channel between the second party computer program and the intermediate party; receiving, from the first party computer program, indices of a first subset of rounds from the first party random bit-string that have the same basis as the intermediate party first randomly chosen basis, are not used for parameter estimation, and were detected by the intermediate party computer program; receiving, from the second party computer program, indices of a second subset of rounds from the second party random bit-string that have the same basis as the intermediate party second randomly chosen basis, are not used for parameter estimation, and were detected by the intermediate party computer program; forming a first party intermediate bit-string using the first intermediate bit-values for rounds that share the same indices announced by the first party and a second party intermediate bit-string using the second intermediate bit-values that share the same indices announced by the second party; announcing, to the first party computer program and to the second party computer program, parities of each bit in the first party intermediate bit-string and each bit in the second party intermediate bit-string; wherein the first party computer program is configured to discard a subset of the bits in the first party random bit-string and announce indices of the discarded bits to the second party computer program; wherein the second party computer program is configured to discard bits corresponding to the indices of the discarded bits from the second party random bit-string; and wherein the first party computer program and the second party computer program are configured to perform error correction and privacy amplification, resulting in a first party secret key and a second party secret key.

In one embodiment, the first party random bit-string comprises a first plurality of randomly chosen bit-values; and the second party random bit-string comprises a second plurality of randomly chosen bit-values.

In one embodiment, the non-transitory computer readable storage medium may also include instructions stored thereon, which when read and executed by the one or more computer processors, cause the one or more computer processors to perform steps comprising: randomly selecting, by the intermediate party computer program, the intermediate party first randomly chosen basis and the intermediate party second randomly chosen basis.

In one embodiment, the first test subset of the first matching rounds and the second test subset of the second set of matching rounds are randomly selected.

In one embodiment, the subset of the bits discarded from the first party random bit-string comprises half of the plurality of bits in the first party random bit-string.

In one embodiment, the first party computer program is configured to announce the indices of the discarded bits to the second party computer program over an encrypted classical communication channel.

In one embodiment, the step of testing a first quantum communication channel between the first party computer program and the intermediate party computer program, and a second quantum communication channel between the second party computer program and the intermediate party comprises: receiving, from the first party computer program, an announcement of a first test subset of the first set of matching rounds and from the second party computer program, an announcement of a second test subset of the second set of matching rounds; and providing, to the first party computer program, the first measurement selected from the first test subset and responding to the second party computer program with the second measurement selected from the second test subset.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for quantum key distribution using semi trusted node quantum networks according to an embodiment;

FIGS. 2A and 2B illustrate a method for quantum key distribution using semi trusted node quantum networks according to an embodiment;

FIG. 3 depicts an exemplary computing system for implementing aspects of the present disclosure.

### DETAILED DESCRIPTION OF PREFERRED EMBODIMENTS

Embodiments relate to systems and methods for quantum key distribution using semi trusted node quantum networks.

In embodiments, each intermediate link only performs the quantum communication, basis announcement, and parameter estimation of the QKD protocol. Next, if parameter estimation step passes for all of the links, the end-users may use an encrypted classical channel to create their respective raw keys. The intermediate nodes may then compute the parity of their raw keys, which allows the end-users to correlate their raw keys. Then, using an encrypted classical channel (e.g., using AES), the end-users may agree on a random substring of their raw key, whose length is half of the original raw key, on which they will perform the classical post-processing (error correction and privacy amplification).

The security against the external adversary is derived from the fact that if the parameter estimation passes for all links, there are two consequences. First, this means that the intermediate keys share very little correlation with the end-users' keys. Second, the external adversary has very little knowledge of all of the intermediate keys such that, from an external adversary's perspective, the announcement is effectively the parity of many random strings, which is not very useful to guess the final key.

On the other hand, the privacy against the intermediate nodes is derived from the fact that even if one has access to the raw key, it is very hard to correctly guess a random substring. Thus, if the encryption scheme leaks very little information about the random substring, it will be unlikely that the intermediate node can correctly guess the final key.

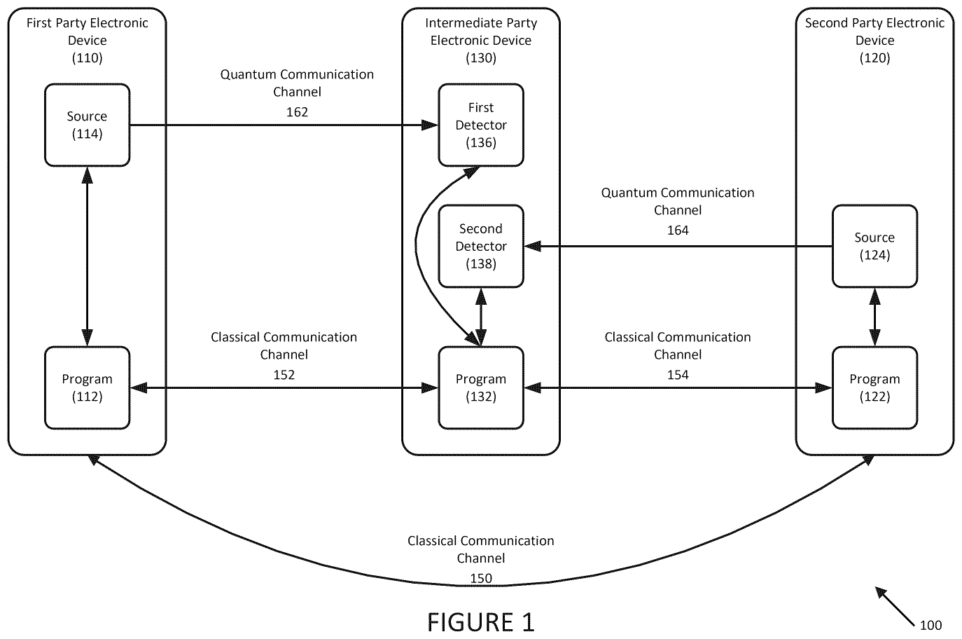

Referring to FIG. 1, a system for quantum key distribution using semi trusted node quantum networks is disclosed according to an embodiment. It should be noted that although FIG. 1 discloses a single intermediate party, additional intermediate parties may be provided as is necessary and/or desired.

System 100 may include first party electronic device 110, second party electronic device 120, and one or more intermediate party electronic devices 130. First party electronic device 110, second party electronic device 120, and intermediate party electronic device(s) 130 each may be a classical (e.g., microprocessor-based) electronic device. Examples of classical electronic devices include servers (e.g., physical and/or cloud-based), computers (e.g., workstations, desktops, laptops, notebooks, tablets, etc.), smart devices (e.g., smart phones), Internet of Things (IoT) appliances, etc.

First party electronic device 110, second party electronic device 120, and intermediate party electronic device(s) may execute first party computer program 112, second party computer program 122, and intermediate party computer program 132, respectively. First party electronic device 110 and second party electronic device 120 may also communicate over classical communication channel 150.

First party computer program 112 may communicate with intermediate party computer program 132 using classical communication channel 152, and second party computer program 122 may communicate with intermediate party computer program 132 using classical communication channel 154.

First party electronic device 110 and second party electronic device 120 may include first party source 114 and second party source 124, respectively. Intermediate party electronic device 130 may include first detector 136 and second detector 138. First party source 114 may communicate with first detector 136 using quantum communication channel 162, and second party source 124 may communicate with second detector 138 using quantum communication channel 164.

A quantum communication channel is a communication channel that is capable of communicating quantum information. Examples include optical fiber, satellite communications, etc.

First party source 114 and second party source 124 may be a source of quantum systems, such as a laser, a single-photon source, an entangled-photon source, light-emitting diodes (LED), etc. First detector 136 and second detector 138 may be devices that may measure quantum systems from first party source 114 and second party source 124, respectively.

A quantum system is a system that behaves according to the principles of quantum mechanics. A quantum system can be prepared in a quantum state, and its properties can be measured by a quantum measurement device. A quantum state has unique properties not observed in classical states, such as quantum superposition, interference, and entanglement. The quantum states are prepared according to one or more basis, which are orthogonal states (e.g., x-basis state and y-basis states) for qubits.

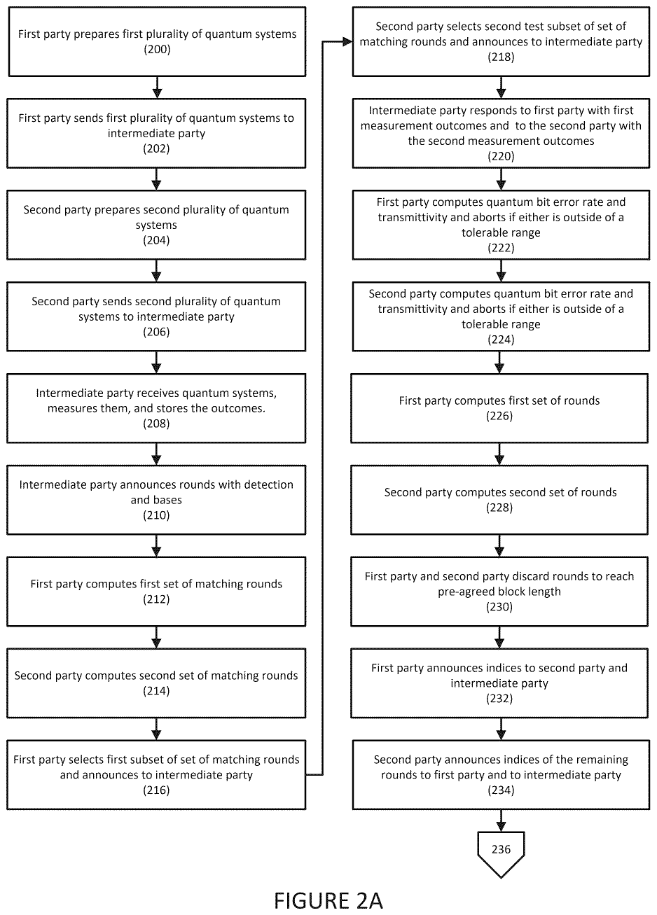

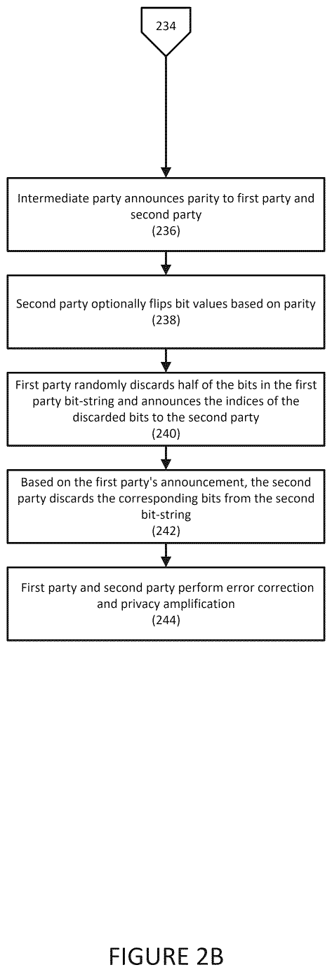

Referring to FIGS. 2A and 2B, a method for quantum key distribution using semi trusted node quantum networks is disclosed according to an embodiment.

In step 200, using a first quantum source, a first party computer program may prepare a first plurality of quantum systems based on a plurality of first party randomly chosen bases and first party randomly chosen bit-values. The first party computer program may randomly select bases and bit-values to prepare the first plurality of quantum systems.

The relation between the quantum states, the bases, and the bit-values depends on the specific protocol. For example, in the polarization encoded BB84 protocol, when choosing the Z-basis, the quantum source will prepare the horizontal polarization quantum state when the bit-value is “0” and the vertical polarization quantum state when the bit-value is “1”. On the other hand, when choosing the X-basis, the quantum source will prepare the +45 degree polarization quantum state when the bit-value is “0” and the −45 degree polarization quantum state when the bit-value is “1”.

The first party randomly chosen bit-values may be arranged into a first party bit-string.

In step 202, the first party computer program may send the first plurality of quantum systems to an intermediate party over a first quantum communication channel between the first party and the intermediate party.

In step 204, using a second quantum source, a second party computer program may prepare a second plurality of quantum systems based on a second party randomly chosen basis and second party randomly chosen bit-values. The second party computer program may randomly select bases and bit-values to prepare the second plurality of quantum systems.

The second party randomly chosen bit-values may be arranged into a second party bit-string.

In step 206, the second party computer program may send the second plurality of quantum systems to the intermediate party over a second quantum communication channel between the second party and the intermediate party.

In step 208, the intermediate party computer program may receive the first quantum systems and the second quantum systems. The intermediate party computer program may randomly choose a first basis (an intermediate party first randomly chosen basis) to measure the first quantum systems, and a second basis (an intermediate party second randomly chosen basis) to measure the second quantum systems. The intermediate party computer program may then measure the first quantum systems in the intermediate party first randomly chosen basis, and may measure the second quantum systems in the intermediate party second randomly chosen basis.

The intermediate party may measure the first quantum systems and the second quantum systems using detectors.

Whenever the first quantum system is successfully detected, the first measurement will be identified as first intermediate bit-value. Similarly, whenever the second quantum system is successfully detected, the second measurement will be identified as the second intermediate bit-value.

The intermediate party computer program may store the outcome of the first quantum system measurement (e.g., the first intermediate bit-values) as a first measurement and the outcome of the second quantum system measurement (e.g., the second intermediate bit-values) as a second measurement.

In step 210, the intermediate party computer program may announce or broadcast rounds with detections from its detectors, and may announce or broadcast its basis. As used herein, a “round” may include the following: (1) the preparation and sending of quantum systems in the specified quantum states (depending on the randomly chosen first party and second party basis choices and bit-values) and (2) the measurement of quantum systems according to the intermediate party first and second basis choices.

For example, the intermediate party computer program may announce or broadcast the rounds with detections, the first randomly chosen basis to the first party computer program, and the second randomly chosen basis to the second party computer program over authenticated classical communication channels.

In step 212, the first party computer program may compute a first set of matching rounds in which the first party randomly chosen basis match the intermediate party first randomly chosen basis.

In step 214, the second party computer program may compute a second set of matching rounds in which the second party randomly chosen basis match the intermediate party second randomly chosen basis.

The parties may then test the first and second quantum communication channels using test rounds. Test rounds are rounds in a QKD protocol that may be used to estimate the amount of information is being leaked to the adversary (via parameter estimation). To accurately estimate the leakage, a collection of test rounds is needed. The collection of test rounds may be referred to as “a set of test rounds”. For the test rounds, the two parties will exchange the “test round data” with the intermediate party. These refer to the bit-values, basis choices (and/or other information, if needed by the specific protocol) for the corresponding test rounds.

To test the quantum communication channels, in step 216, the first party computer program may randomly choose a first test subset of the first set of matching rounds and may announce or broadcast it to the intermediate party computer program over the authenticated classical channel.

In step 218, the second party computer program may randomly choose a second test subset of the second set of matching rounds and may announce or broadcast it to the intermediate party computer program over the authenticated classical channel.

In step 220, the intermediate party computer program may respond to the first party computer program with the first measurement outcomes selected from the first test subset and may respond to the second party computer program with the second measurement outcomes selected from the second test subset.

In step 222, the first party computer program may estimate a first quantum bit error rate and first transmittivity of the quantum communication channel between it and the intermediate party, and may abort if either is outside of a tolerable range. The first quantum bit error rate is the probability that for any given round in a QKD protocol, the intermediate party detects the first quantum system and the first party's bit-value does not match the first measurement in that round.

The first transmittivity is the probability that for any given round in a QKD protocol, the intermediate party detects the first quantum system in that round.

In one embodiment transmittivity may be estimated by dividing the number of detections in the test subset by the number of rounds in the test subset, and the quantum bit error rate may be determined by dividing the number of errors in the test subset by the number of detections in the test subset.

In one embodiment the tolerable range (or threshold) may be chosen based on the expected behavior of the quantum communication channel, accounting for the expected noise and loss, with some small tolerance so that the protocol is not aborted with high probability. The expected behavior can be obtained during the calibration when setting up the QKD devices.

In step 224, the second party computer program may estimate a second quantum bit error rate and second transmittivity of the quantum communication channel between it and the intermediate party, and may abort if either is outside of a tolerable range.

The second quantum bit error rate is the probability that the intermediate party detects the second quantum system and the second party's bit-value does not match the second detector's measurement outcome. The second transmittivity is the probability that the intermediate party detects the second quantum system.

In step 226, the first party computer program may compute a first subset of rounds from step 216 where the first party chooses the same basis as the intermediate party, are not used for parameter estimation, and where the intermediate party had a detection.

In step 228, the second party computer program may compute a second subset of rounds from step 218 where the second party chooses the same basis as the intermediate party, are not used for parameter estimation, and where the intermediate party had a detection.

Based on a pre-agreed block length, in step 230, the first party and the second party may discard some rounds randomly until the remaining number of rounds for both parties are equal to the pre-agreed block length. The first party forms the first bit-string by taking the bit-values of associated to the remaining rounds of the first party. The second party forms the second bit-string by taking the bit-values of associated to the remaining rounds of the second party.

In step 232, the first party computer program may announce or broadcast indices of the remaining rounds (i.e., rounds that were not discarded) to the second party and to the intermediate party. The intermediate party may form a first intermediate bit-string using the first measurement outcomes of the first quantum systems, taken from the remaining rounds announced of broadcasted by the first party. The index of a round may be given by the order in which the round is executed in the protocol. For example, the first round in the protocol will be given the index “1”, the second round in the protocol will be given the index “2”, and so on.

In step 234, the second party computer program may announce or broadcast indices of the remaining rounds (i.e., rounds that were not discarded) to the first party and to the intermediate party. The intermediate party may form a second intermediate bit-string using the second measurement outcomes of the second quantum systems, taken from the remaining rounds announced or broadcasted by the second party.

In step 236, the intermediate party computer program may announce or broadcast the parity of each bit in the first intermediate bit-string and the second intermediate bit-string. For example, the intermediate party may announce or broadcast whether the j-th bit from the first intermediate bit-string is equal to the j-th bit from the second intermediate bit-string.

In step 238, the second party computer program may flip the j-th bit-value if the intermediate party announces or broadcasts that the first party's j-th bit-value is not equal to the second party's j-th bit-value in step 236. Otherwise (i.e., if the intermediate party announces or broadcasts that the first party's j-th bit-value is equal to the second party's j-th bit-value in step 236), the second party computer program does nothing.

In step 240, the first party may randomly discard half of the bits in the first party bit-string. Then, using an encrypted classical communication channel, the first party announces or broadcasts to the second party the indices of the discarded bits.

In step 242, based on the first party's announcement in the encrypted classical channel, the second party discards the bits from the second bit-string that correspond to the indices of the discarded bits from the first party.

In step 244, using an encrypted classical channel, the first party computer program and the second party computer program may perform error correction and privacy amplification on their remaining bits. The result of the error correction is the first party corrected key and the second party corrected key.

Privacy amplification takes in the first party corrected key and the second party corrected key and outputs the first party secret key and the second party secret key, respectively.

In one embodiment, more than one intermediate node may be provided. In this case, parameter estimation may be done for every quantum communication channel, and all intermediate nodes announce or broadcasts the parity bits.

In one embodiment, the role of senders and receivers can be easily swapped (e.g., in entanglement-based protocols both parties are receivers and in MDI-QKD protocols both parties are senders)/

In one embodiment, decoy states may be used. For practical implementations that use weak lasers, it is customary to use decoy-states. The senders of quantum systems may choose the intensity of the lasers randomly in each round. Vacuum and single-photon yield and phase-error rate are estimated during the parameter estimation step.

In one embodiment, each party may perform the standard QKD protocols with their neighbors, and the intermediate parties may announce or broadcast the parity bits of their keys. Using an encrypted classical channel, the first party may choose a random substring of their keys, and may inform the second party about the chosen substring afterwards.

Examples of systems and methods for quantum key distribution are disclosed in U.S. patent application Ser. No. 18/174,768 and U.S. patent application Ser. No. 18/305,039, the disclosure of which are hereby incorporated, by reference, in their entireties.

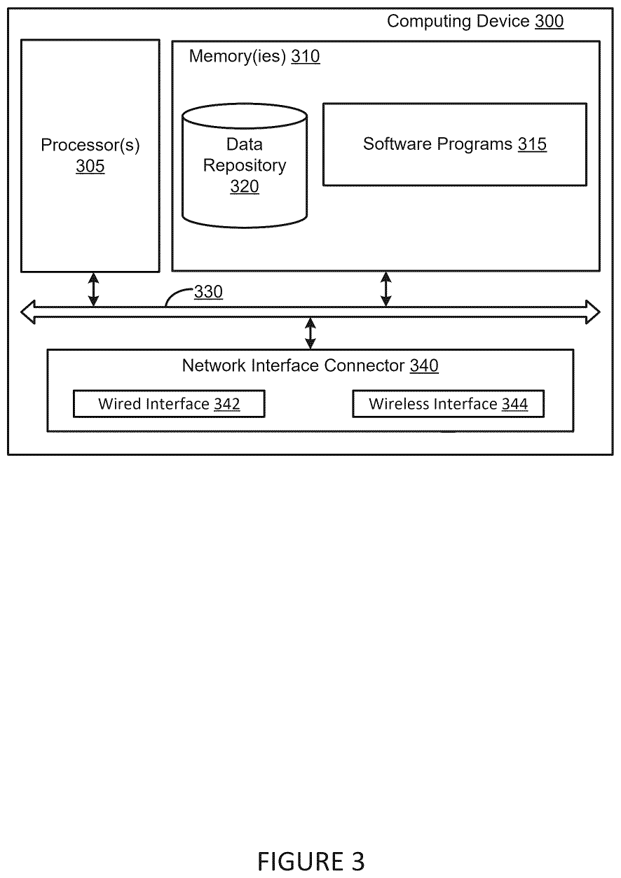

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by an intermediate party computer program and from a first party computer program, a first plurality of quantum systems prepared according to first party random bases and a first party random bit-string;
receiving, by the intermediate party computer program and from a second party computer program, a second plurality of quantum systems prepared according to second party random bases and a second party random bit-string;
measuring, by the intermediate party computer program, each of the first plurality of quantum systems as a first measurement using an intermediate party first randomly chosen basis and each of the second plurality of quantum systems as a second measurement using an intermediate party second randomly chosen basis, wherein the first measurements comprise first intermediate bit-values and the second measurement comprise second intermediate bit-values;
announcing, by the intermediate party computer program and from the first measurements, a first set of matching rounds with detections to the first party computer program, and, from the second measurements, a second set of matching rounds with detections to the second party computer program;
testing, by the intermediate party computer program, a first quantum communication channel between the first party computer program and the intermediate party computer program, and a second quantum communication channel between the second party computer program and the intermediate party;
receiving, by the intermediate party computer program and from the first party computer program, indices of a first subset of rounds from the first party random bit-string that have the same basis as the intermediate party first randomly chosen basis, are not used for parameter estimation, and were detected by the intermediate party computer program;
receiving, by the intermediate party computer program and from the second party computer program, indices of a second subset of rounds from the second party random bit-string that have the same basis as the intermediate party second randomly chosen basis, are not used for parameter estimation, and were detected by the intermediate party computer program;
forming, by the intermediate party computer program, a first party intermediate bit-string using the first intermediate bit-values for rounds that share the same indices announced by the first party and a second party intermediate bit-string using the second intermediate bit-values that share the same indices announced by the second party;
announcing, by the intermediate party computer program and to the first party computer program and to the second party computer program, parities of each bit in the first party intermediate bit-string and each bit in the second party intermediate bit-string;
wherein the first party computer program is configured to discard a subset of the bits in the first party random bit-string and announce indices of the discarded bits to the second party computer program;
wherein the second party computer program is configured to discard bits corresponding to the indices of the discarded bits from the second party random bit-string; and
wherein the first party computer program and the second party computer program are configured to perform error correction and privacy amplification, resulting in a first party secret key and a second party secret key.

2. The method of claim 1, wherein:
the first party random bit-string comprises a first plurality of randomly chosen bit-values; and
the second party random bit-string comprises a second plurality of randomly chosen bit-values.

3. The method of claim 1, further comprising:
randomly selecting, by the intermediate party computer program, the intermediate party first randomly chosen basis and the intermediate party second randomly chosen basis.

4. The method of claim 1, wherein a first test subset of the first set of matching rounds and a second test subset of the second set of matching rounds are randomly selected.

5. The method of claim 1, wherein the subset of the bits discarded from the first party random bit-string comprises half of the plurality of bits in the first party random bit-string.

6. The method of claim 1, wherein the first party computer program is configured to announce the indices of the discarded bits to the second party computer program over an encrypted classical communication channel.

7. The method of claim 1, wherein the step of testing the first quantum communication channel between the first party computer program and the intermediate party computer program, and the second quantum communication channel between the second party computer program and the intermediate party comprises:
receiving, by the intermediate party computer program and from the first party computer program, an announcement of a first test subset of the first set of matching rounds and from the second party computer program, an announcement of a second test subset of the second set of matching rounds; and
providing, by the intermediate party computer program and to the first party computer program, first measurements for the first test subset and providing the second party computer program with second measurements for the second test subset.

8. A system, comprising:
a first party electronic device executing a first party computer program;
a second party electronic device executing a second party computer program; and
an intermediate party electronic device executing an intermediate party computer program;
wherein:
the first party computer program prepares a first plurality of quantum systems according to first party random bases and a first party random bit-string and sends the first plurality of quantum systems to an intermediate party computer program;
the second party computer program prepares a second plurality of quantum systems according to second party bases and a second party random bit-string and sends the second plurality of quantum systems to the intermediate party computer program;
the intermediate party computer program measures the first plurality of quantum systems as a first measurement using an intermediate party first randomly chosen basis and the second plurality of quantum systems as a second measurement using an intermediate party second randomly chosen basis, wherein the first measurements comprise first intermediate bit-values and the second measurement comprise second intermediate bit-values;
the intermediate party computer program announces, from the first measurements, a first set of matching rounds with detections to the first party computer program, and, from the second measurements, a second set of matching rounds with detections to the second party computer program;
the intermediate party computer program tests a first quantum communication channel between the first party computer program and the intermediate party computer program, and a second quantum communication channel between the second party computer program and the intermediate party;
the intermediate party computer program receives, from the first party computer program, indices of a first subset of rounds from the first party random bit-string that have the same basis as the intermediate party first randomly chosen basis, are not used for parameter estimation, and were detected by the intermediate party computer program;
the intermediate party computer program receives, from the second party computer program, indices of a second subset of rounds from the second party random bit-string that have the same basis as the intermediate party second randomly chosen basis, are not used for parameter estimation, and were detected by the intermediate party computer program;
the intermediate party computer program forms a first party intermediate bit-string using the first intermediate bit-values for rounds that share the same indices announced by the first party and a second party intermediate bit-string using the second intermediate bit-values that share the same indices announced by the second party;
the intermediate party computer program announces, to the first party computer program and to the second party computer program, parities of each bit in the first party intermediate bit-string and each bit in the second party intermediate bit-string;
the first party computer program discards a subset of the bits in the first party random bit-string and announce indices of the discarded bits to the second party computer program;
the second party computer program discards bits corresponding to the indices of the discarded bits from the second party random bit-string; and
the first party computer program and the second party computer program perform error correction and privacy amplification, resulting in a first party and a second party secret key.

9. The system of claim 8, wherein:
the first party computer program randomly chooses the first party random bit-string and the first party random bases, and the first party random bit-string comprises a first plurality of randomly chosen bit-values; and
the second party computer program randomly chooses the second party random bit-string and the second random basis, and the second party random bit-string comprises a second plurality of randomly chosen bit-values.

10. The system of claim 8, wherein the intermediate party computer program measures the first plurality of quantum systems in intermediate party first randomly chosen bases, the second plurality of quantum systems in intermediate party second randomly chosen bases, and the intermediate party computer program announces the intermediate party first randomly chosen bases to the first party computer program, and the intermediate party second randomly chosen bases to the second party computer program.

11. The system of claim 8, wherein:
the first party computer program computes the first set of matching rounds with matching basis and selecting a first test subset of the first set of matching rounds; and
the second party computer program computes the second set of matching rounds with matching basis and selecting a second test subset of the second set of matching rounds.

12. The system of claim 8, wherein the subset of the bits discarded from the first party random bit-string comprises half of the plurality of bits in the first party random bit-string.

13. The system of claim 8, wherein the intermediate party computer program tests the first quantum communication channel between the first party computer program and the intermediate party computer program, and the second quantum communication channel between the second party computer program and the intermediate party by:
the intermediate party computer program receiving, from the first party computer program, an announcement of a first test subset of the first set of matching rounds and from the second party computer program, an announcement of a second test subset of the second set of matching rounds; and
the intermediate party computer program providing, to the first party computer program, the first measurement selected from the first test subset and responding to the second party computer program with the second measurement selected from the second test subset.

14. A non-transitory computer readable storage medium, including instructions stored thereon, which when read and executed by one or more computer processors for an intermediate party, cause the one or more computer processors to perform steps comprising:
receiving, from a first party computer program, a first plurality of quantum systems prepared according to first party random bases and a first party random bit-string;
receiving, from a second party computer program, a second plurality of quantum systems prepared according to second party random bases and a second party random bit-string;
measuring, the first plurality of quantum systems as a first measurement using an intermediate party first randomly chosen basis and the second plurality of quantum systems as a second measurement using an intermediate party second randomly chosen basis, wherein the first measurements comprise first intermediate bit-values and the second measurement comprise second intermediate bit-values;
announcing, from the first measurements, a first set of matching rounds with detections to the first party computer program, and, from the second measurements, a second set of matching rounds with detections to the second party computer program;
testing a first quantum communication channel between the first party computer program and the intermediate party, and a second quantum communication channel between the second party computer program and the intermediate party;
receiving, from the first party computer program, indices of a first subset of rounds from the first party random bit-string that have the same basis as the intermediate party first randomly chosen basis, are not used for parameter estimation, and were detected;
receiving, from the second party computer program, indices of a second subset of rounds from the second party random bit-string that have the same basis as the intermediate party second randomly chosen basis, are not used for parameter estimation, and were detected;
forming a first party intermediate bit-string using the first intermediate bit-values for rounds that share the same indices announced by the first party and a second party intermediate bit-string using the second intermediate bit-values that share the same indices announced by the second party; and
announcing, to the first party computer program and to the second party computer program, parities of each bit in the first party intermediate bit-string and each bit in the second party intermediate bit-string;
wherein the first party computer program is configured to discard a subset of the bits in the first party random bit-string and announce indices of the discarded bits to the second party computer program;
wherein the second party computer program is configured to discard bits corresponding to the indices of the discarded bits from the second party random bit-string; and
wherein the first party computer program and the second party computer program are configured to perform error correction and privacy amplification, resulting in a first party secret key and a second party secret key.

15. The non-transitory computer readable storage medium of claim 14, wherein:
the first party random bit-string comprises a first plurality of randomly chosen bit-values; and
the second party random bit-string comprises a second plurality of randomly chosen bit-values.

16. The non-transitory computer readable storage medium of claim 14, further including instructions stored thereon, which when read and executed by the one or more computer processors, cause the one or more computer processors to perform steps comprising:
randomly selecting the intermediate party first randomly chosen basis and the intermediate party second randomly chosen basis.

17. The non-transitory computer readable storage medium of claim 14, wherein a first test subset of the first set of matching rounds and a second test subset of the second set of matching rounds are randomly selected.

18. The non-transitory computer readable storage medium of claim 14, wherein the subset of the bits discarded from the first party random bit-string comprises half of the plurality of bits in the first party random bit-string.

19. The non-transitory computer readable storage medium of claim 14, wherein the first party computer program is configured to announce the indices of the discarded bits to the second party computer program over an encrypted classical communication channel.

20. The non-transitory computer readable storage medium of claim 14, wherein the step of testing a first quantum communication channel between the first party computer program and the intermediate party, and a second quantum communication channel between the second party computer program and the intermediate party comprises:
receiving, from the first party computer program, an announcement of a first test subset of the first set of matching rounds and from the second party computer program, an announcement of a second test subset of the second set of matching rounds; and
providing, to the first party computer program, the first measurement selected from the first test subset and responding to the second party computer program with the second measurement selected from the second test subset.
